(19) United States
(12) Patent Application Publication
(10) Pub. No.: US 2021/0333498 A1
(43) Pub. Date: Oct. 28, 2021

(54) FAN-OUT DISTRIBUTION BOX WITH ISOLATING FIBER CHAMBER

(71) Applicant: COMMSCOPE TECHNOLOGIES LLC, Hickory, NC (US)

(72) Inventors: Norin P. PAUSAN, St Asaph (GB); Stuart MUDGE, Gillingham (GB); Darren Craig ATKINSON, Halstead, Essex (GB); Daniel Eduardo HERRERA VELAZQUEZ, Juarez, Chihuahua (MX); Roman KAMENIK, Kuparovice (CZ); Emmanuel Alberto ALTAMIRANO ESCOBEDO, Juarez, Chihuahua (MX); Patrick Jacques Ann DIEPSTRATEN, Heusden-Zolder (BE)

(21) Appl. No.: 17/264,672

(22) PCT Filed: Jul. 31, 2019
(86) PCT No.: PCT/US2019/044386

§ 371 Date: Jan. 29, 2021

Related U.S. Application Data
(60) Provisional application No. 62/713,172, filed on Aug. 1, 2018.

(51) Int. Cl. G02B 6/44

(52) U.S. Cl. CPC G02B 6/4446; G02B 6/4483

(57) ABSTRACT

The present disclosure relates to a hardened fan-out assembly having an isolated chamber for protecting routed optical fibers from exposure to epoxy resin (e.g., adhesive material).

### CROSS-REFERENCE TO RELATED APPLICATION

This application is being filed on Jul. 31, 2019 as a PCT International Patent Application and claims the benefit of U.S. Patent Application Ser. No. 62/713,172, filed on Aug. 1, 2018, the disclosure of which is incorporated herein by reference in its entirety.

### TECHNICAL FIELD

The present disclosure relates generally to telecommunications cable assemblies, more particularly, relates to fiber optic connection arrangements.

### BACKGROUND

Fiber optic telecommunications connectivity is being extended as part of fiber-to-the-home (FTTH) and/or fiber-to-the-premises (FTTP) efforts which are currently ongoing. In the effort to expand fiber optic connectivity, it is desirable to provide fiber optic connection locations in the vicinity of subscriber locations. Often, such fiber optic connection locations can be provided below grade (e.g., in hand-holes) at grade or aerially (e.g. on a pole). Thus, it is desirable for such connection locations to be hardened so as to be capable of withstanding outdoor environmental conditions. Often, hardened fiber optic connection locations are provided by multi-service terminals (e.g., drop terminals) which include hardened ports adapted for receiving hardened fiber optic connectors. Example multi-service terminals are disclosed by PCT publication number WO2008/118603; U.S. Pat. Nos. 7,397,997; and 7,844,158. Fiber optic connection devices having connectorized pigtails have also been developed. Example fiber optic connection devices of this type are disclosed by PCT Publication No. WO2014/197894; PCT Publication No. WO2014/167447; PCT Publication No. WO2014/123940; U.S. Pat. Nos. 7,277,614 and 7,428,366.

### SUMMARY

One aspect of the present disclosure relates to a hardened fan-out assembly having an isolated chamber for protecting routed optical fibers from exposure to filling material (e.g., adhesive material, epoxy resin).

Another aspect of the present disclosure relates to a hardened fan-out device that includes an outer housing that has a main body formed by a base and an outer cover. The outer housing has a first end and an opposite second end. An inner housing configured to be located inside of the outer housing, the inner housing can have a distal end and a proximal end that respectively align with the first and second ends of the outer housing. A space can be defined circumferentially between the outer housing and the inner housing where the space can be adapted to form a flow passage for a filling material. An inner cover adapted to be positioned over and fitted on the inner housing such that the filling material is prevented from flowing into the inner housing. The outer cover can be adapted to be positioned over and fitted on the outer housing such that the space and the inner cover of the inner housing are enclosed.

Another aspect of the present disclosure relates to a hardened fiber optic fan-out arrangement that can include a hardened fan-out device with an in-line configuration. The hardened fan-out device includes: 1) an outer housing that has a first end and an opposite second end; 2) an inner housing configured to be located inside of the outer housing, the inner housing has a distal end and a proximal end that respectively align with the first and second ends of the outer housing; 3) a space defined circumferentially between the outer housing and the inner housing, the space can be adapted to form a flow passage for a filling material; and 4) an inner cover adapted to be positioned over and fitted on the inner housing such that the filling material is prevented from flowing into the inner housing. The arrangement can also include an outer cover that can be adapted to be positioned over and fitted on the outer housing such that the space and the inner cover of the inner housing are enclosed; a plurality of fiber optic pigtails that project outwardly from the second end of the hardened fan-out device; and a fiber optic feeder cable that projects outwardly from the first end of the hardened fan-out device. The fiber optic feeder cable can be optically coupled to the fiber optic pigtails where optical fibers are routed from the fiber optic feeder cable through the hardened fan-out device to the plurality of fiber optic pigtails. The filling material encapsulates an end of the fiber optic feeder cable within the outer housing and encapsulates ends of the plurality of fiber optic pigtails within the outer housing. The filling material does not encapsulate the optical fibers within the inner housing.

A further aspect of the present disclosure relates to a method of fabricating a fan-out assembly for a fiber optic feeder cable which includes a plurality of fiber optic pigtails. The method includes steps of 1) providing a hardened fan-out device, the hardened fan-out device can have an outer housing and an inner housing, a space can be defined between the outer and inner housings; 2) routing optical fibers from the fiber optic feeder cable through the hardened fan-out device to the plurality of fiber optic pigtails; 3) terminating free ends of the plurality of fiber optic pigtails to a plurality of fiber optic connectors; 4) routing excess slack of the optical fibers about a spool positioned within the inner housing of the hardened fan-out device; 5) covering the inner housing of the hardened fan-out device with an inner cover; 6) applying filling material over the inner housing and into the space defined between the outer and inner housings where the filling material does not enter the inner housing; and 7) covering the outer housing of the hardened fan-out device with an outer cover to enclose the inner cover and inner housing of the hardened fan-out device.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the examples disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of a hardened fiber optic fan-out assembly in accordance with principles of the present disclosure;

FIG. 2 is a plan view of a hardened fan-out device of the fan-out assembly of FIG. 1 with an outer cover removed to depict an inner housing;

FIG. 3 is an end view of the hardened fan-out device of FIG. 2 showing an inner cover mounted over the inner housing of the hardened fan-out device;

FIG. 4 is a plan view of the hardened fan-out device with a fiber optic feeder cable with optical fibers extended therefrom;

FIG. 5 is a plan view of the hardened fan-out device of FIG. 4 depicting the fiber optic feeder cable with a heat shrink;

FIG. 6 is a perspective view of a sealing gel block including empty tubes for receiving routed optical fibers and crimp bands and also showing a filling material being added within the sealing gel block in accordance with the principles of the present disclosure;

FIG. 7 is a plan view of the hardened fan-out device showing the sealing gel block of FIG. 6 mounted thereon and also showing the optical fibers routed about a cable storage spool into the empty tubes;

FIG. 7A is a cross-sectional view taken along section line 7A-7A of FIG. 7;

FIG. 7B is a cross-sectional view of a fiber optic cable taken along section line 7B-7B of FIG. 4;

FIG. 7C is a cross-sectional view depicting one of the optical fibers of the fiber optic cable of FIG. 7B;

FIG. 8 is a plan view of the hardened fan-out device of FIG. 7 including a boot structure mounted to the sealing gel block;

FIG. 9 is a plan view of the hardened fan-out device showing a hardened style connector body that includes a heat shrink;

FIG. 10 is a plan view of free ends of a plurality of pigtails of the hardened fiber optic fan-out assembly;

FIG. 11 is a perspective view showing the free ends of FIG. 10 connectorized in accordance with the principles of the present disclosure;

FIG. 12 is a plan view of the hardened fiber optic fan-out assembly of FIG. 1 showing slack of the optical fibers pulled back inside of the hardened fan-out device after termination;

FIG. 13 is a plan view of the hardened fiber optic fan-out assembly of FIG. 12 showing the slack of the optical fibers coiled around the cable storage spool;

FIG. 14 is a plan view of the hardened fiber optic fan-out assembly of FIG. 13 showing the optical fibers held by fiber retention arms;

FIGS. 15-16 are perspective views of the hardened fiber optic fan-out assembly of FIG. 13 depicting additional optical fibers routed through the hardened fan-out device and connectorized, also showing the optical fibers coiled about the cable storage spool;

FIG. 17 is a plan view of the hardened fiber optic fan-out assembly of FIG. 15 with the inner cover added in accordance with the principles of the present disclosure;

FIG. 18 is a plan view of the hardened fan-out device of FIG. 17 showing the filling material within an interior volume of the hardened fan-out device and outside of the inner housing to encapsulate an end of the fiber optic feeder cable and ends of the plurality of pigtails;

FIG. 19 is a perspective view of the hardened fan-out device of FIG. 1 taken from a first perspective;

FIG. 20 is a perspective view of the hardened fan-out device of FIG. 19 taken from an opposite, second perspective;

FIG. 21 is a perspective view of the hardened fan-out device of FIG. 19 taken from another side perspective;

FIG. 22 is a perspective view of the hardened fan-out device of FIG. 20 taken from a bottom perspective view;

FIG. 23 is a plan view of the hardened fan-out device of FIG. 19;

FIG. 24 is a plan view of an opposite, bottom view of the hardened fan-out device of FIG. 23;

FIG. 25 is a side view of the hardened fan-out device of FIG. 19;

FIG. 26 is an end view of the hardened fan-out device of FIG. 19;

FIG. 27 is an opposite, end view of the hardened fan-out device of FIG. 26;

FIG. 28 is a cross-sectional view taken along section line 28-28 of FIG. 24;

FIG. 29 is an exploded view of the hardened fan-out device of FIG. 19;

FIG. 30 is an exploded view of the hardened fan-out device of FIG. 29;

FIG. 31 is a plan view of the hardened fan-out device of FIG. 30 showing the interior thereof;

FIG. 32 is a perspective view of an end-wall structure of the inner housing of the hardened fan-out device of FIG. 30; and

FIGS. 33-35 are multiple views of the inner cover depicted in FIGS. 29 and 30.

### DETAILED DESCRIPTION

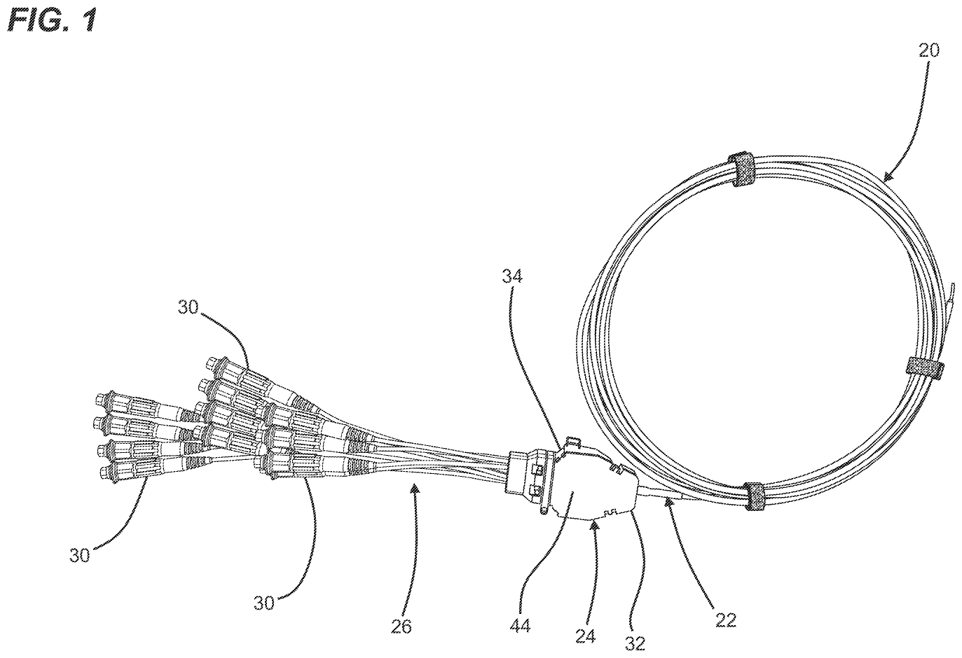

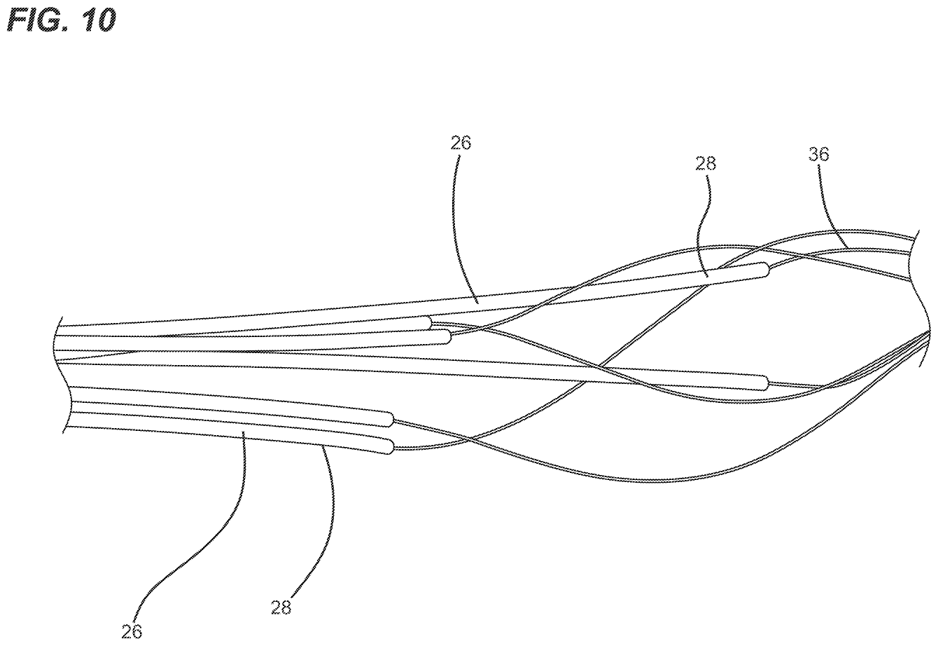

FIG. 1 illustrates a hardened fiber optic fan-out (e.g., break-out) assembly 20 in accordance with the principles of the present disclosure. The hardened fiber optic fan-out assembly 20 includes a fiber optic feeder cable 22, a hardened fan-out (e.g., break-out) device 24, and a plurality of fiber optic pigtails 26. Preferably, the plurality of fiber optic pigtails 26 have free-ends 28 (see FIG. 10) including hardened (e.g., ruggedized) fiber optic connectors. The fiber optic connectors may include hardened mateable or de-mateable fiber optic connection interfaces 30. That is, the hardened fiber optic connectors may include hardened female fiber optic connectors or hardened male fiber optic connectors. The hardened fiber optic connection interfaces 30 can include single fiber or multi-fiber (e.g., duplex or more than two fibers) fiber optic connectors. The hardened fiber optic connection interfaces 30 can include twist-to-lock connection interfaces. The twist-to-lock connection interfaces can include threads or bayonet style connection interfaces.

By hardened or ruggedized, it is meant that fiber optic connectors or fiber optic adapter ports are adapted for outside environmental use. For example, ruggedized fiber optic adapter ports and ruggedized fiber optic connectors can include environmental seals for preventing moisture/water intrusion.

In the depicted example, the hardened fan-out device 24 has an in-line configuration in which the fiber optic feeder cable 22 extends (e.g., projects outwardly) from a first end 32 of the hardened fan-out device 24 and the plurality of fiber optic pigtails 26 extend (e.g., projects outwardly) from an opposite second end 34 of the hardened fan-out device 24. Thus, the fiber optic feeder cable 22 and the plurality of fiber optic pigtails 26 extend outwardly from the hardened fan-out device 24 in opposite directions. While it is preferred for the hardened fan-out device 24 to have an in-line configuration, it will be appreciated that in other examples the plurality of fiber optic pigtails 26 and the fiber optic feeder cable 22 can extend outwardly from the hardened fan-out device 24 in the same direction from one end of the hardened fan-out device 24, or can be angled relative to each other (e.g., oriented at right angles, acute angles or obtuse angles). In the example depicted, the fiber optic feed cable 22 is the same as the plurality of fiber optic pigtails 26 which is routed through the hardened fan-out device 24. That is, the fiber optic feed cable 22 is routed through the hardened fan-out device 24 without any splices. In other examples, the fiber optic feed cable 22 may be optically coupled to the plurality of fiber optic pigtails 26.

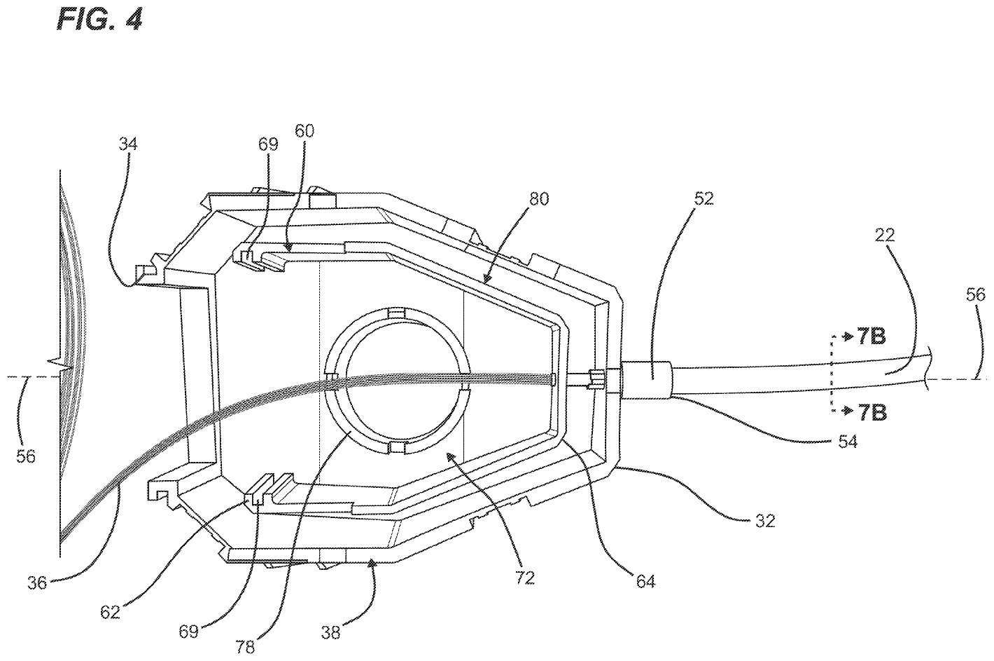

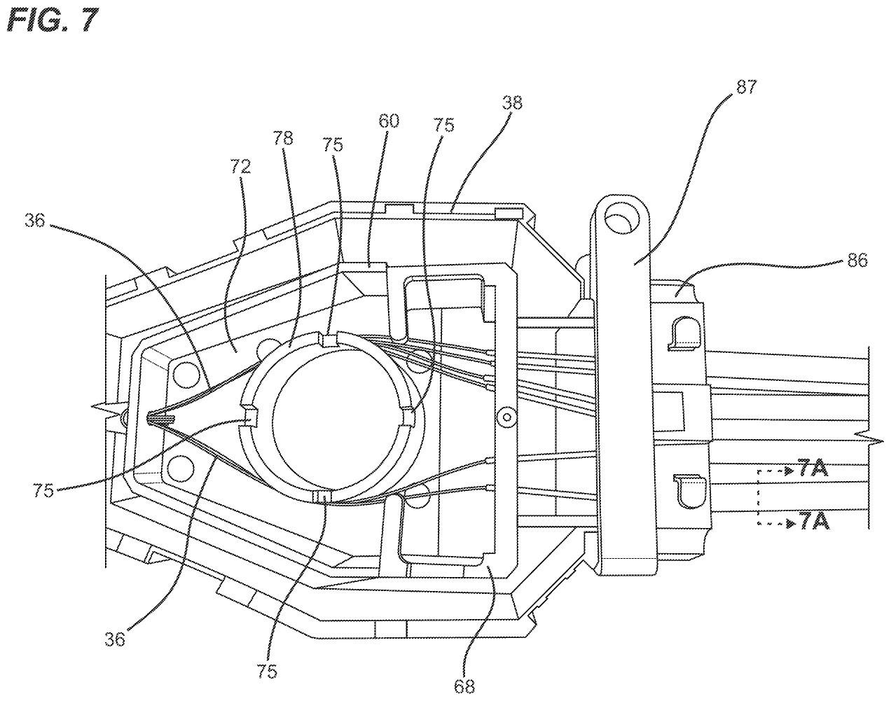

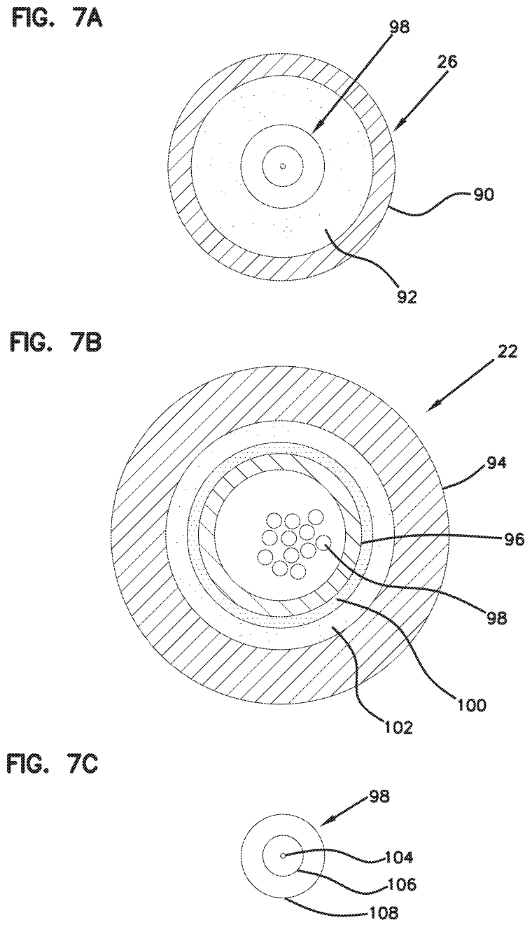

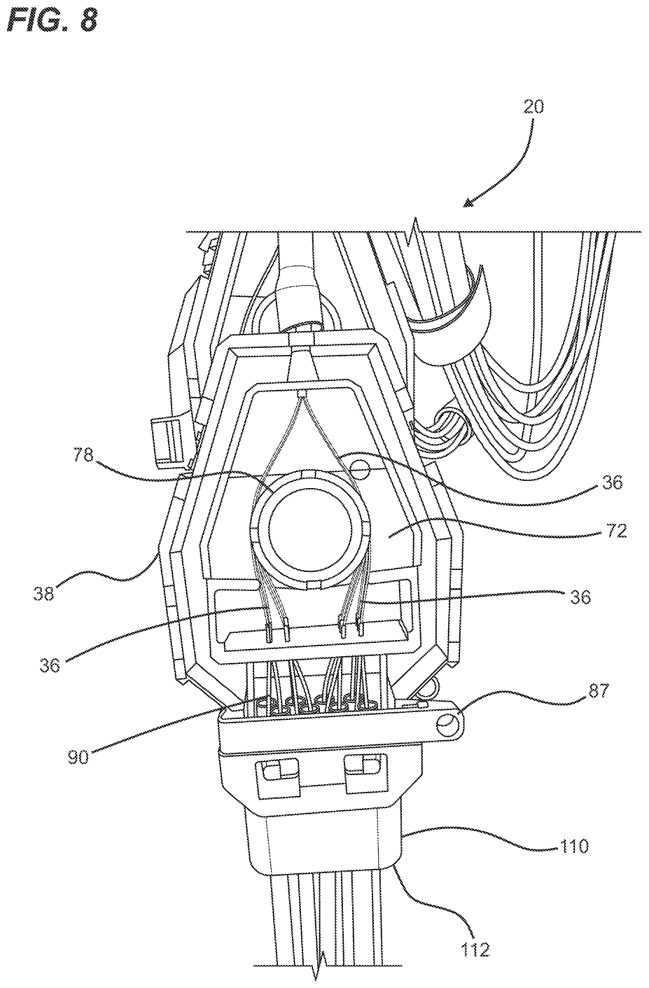

It will be appreciated that the fiber optic feeder cable 22 preferably includes a plurality of optical fibers 36 (see FIG. 4) that are fanned-out from one another within the hardened fan-out device 24 and routed individually to the plurality of fiber optic pigtails 26 as shown in FIGS. 7 and 8. In certain examples, the fiber optic feeder cable 22 includes four to twelve optical fibers 36 and a corresponding number of fiber optic pigtails 26 are provided, although alternatives are possible. For example, any desired number of optical fibers and corresponding pigtails may be included.

In certain examples, the fiber optic feeder cable 22 includes at least four optical fibers 36 and the hardened fiber optic fan-out assembly 20 includes at least four fiber optic pigtails 26. In other examples, the fiber optic feeder cable 22 includes at least two optical fibers 36 and the hardened fiber optic fan-out assembly 20 includes at least two fiber optic pigtails 26. In other examples, the fiber optic feeder cable 22 includes at least four optical fibers 36 and the hardened fiber optic fan-out assembly 20 includes at least four fiber optic pigtails 26. In other examples, the fiber optic feeder cable 22 includes at least eight optical fibers 36 and the hardened fiber optic fan-out assembly 20 includes at least eight fiber optic pigtails 26. In still other examples, the fiber optic feeder cable 22 includes at least twelve optical fibers 36 and the hardened fiber optic fan-out assembly 20 includes at least twelve fiber optic pigtails 26. In other examples, more than one optical fiber 36 can be routed through at least some of the fiber optic pigtails 26. For example, at least some of the fiber optic pigtails 26 can include two optical fibers 36 and can have free ends 28 terminated by hardened duplex fiber optic connectors. Alternatively, at least some of the fiber optic pigtails 26 can include more than two optical fibers 36 and can have free ends 28 terminated by hardened multi-fiber fiber optic connectors that can accommodate more than two optical fibers 36 (e.g., the connectors can include ferrules that each receive more than two optical fibers). The fiber optic connectors can include ferruled connectors and ferrule-less connectors (examples of ferrule-less connectors are shown by PCT Publication No. WO 2013/117598, which is hereby incorporated by reference in its entirety).

As depicted by the example shown in FIG. 1, the hardened fiber optic fan-out assembly 20 includes sets of pigtails with the pigtails of each set having a different length. This assists in staggering at least some of the connectorized ends of the pigtails when the pigtails are extended. In other examples, all the pigtails can have the same length or all of the pigtails can have different lengths.

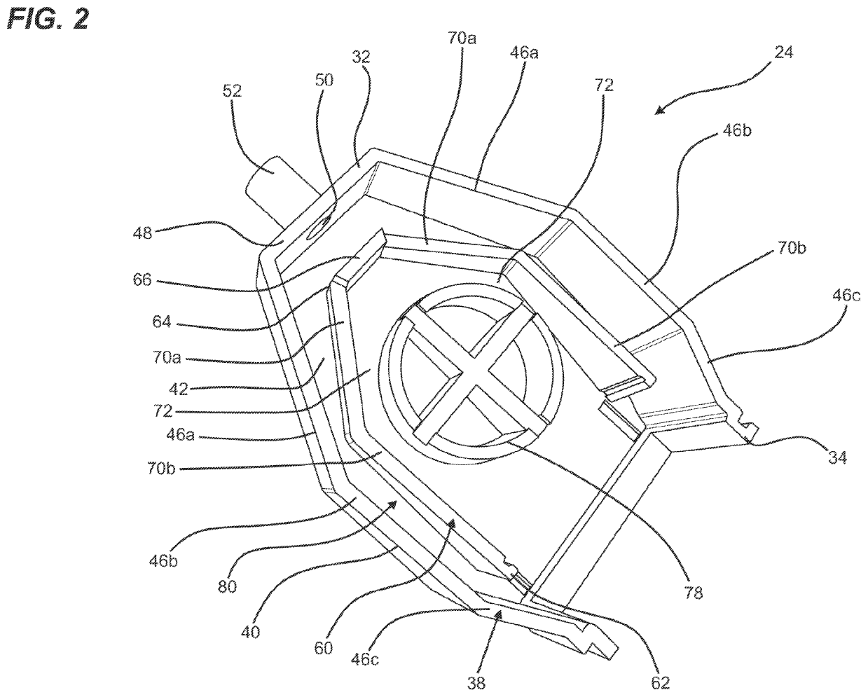

Referring to FIG. 2, the hardened fan-out device 24 includes an outer housing 38 having a main body 40 formed by a base 42 and an outer cover 44 (e.g., first cover) (see FIG. 1). The main body 40 of the outer housing 38 can include three pairs of opposing side walls 46a-c and an end wall 48. The three pairs of opposing side walls 46a-c and the end wall 48 extend upwardly from the base 42. At least two of the three pairs of opposing side walls 46a-c are tapering walls, although alternatives are possible. The end wall 48 can be positioned at the first end 32 of the outer housing 38 of the hardened fan-out device 24 and defines a first opening 50. The outer housing 38 has a tapered configuration when viewed in plan view as shown by FIG. 4. In certain examples, the three pairs of opposing side walls 46a-c may include three pairs of identical opposing side walls, although alternatives are possible.

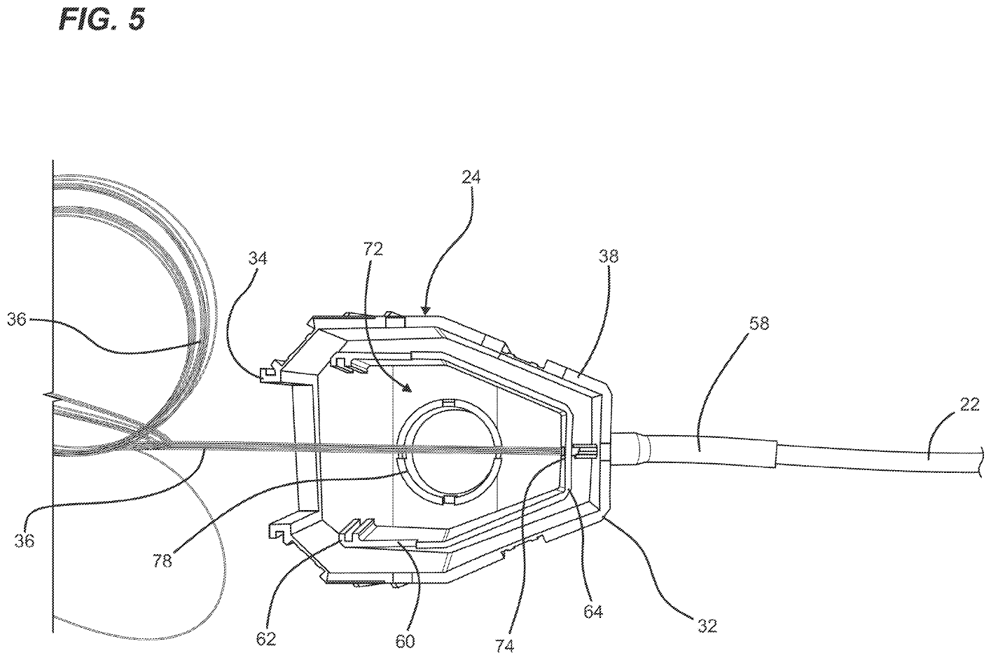

A stub 52 is shown projecting outwardly from the end wall 48 of the main body 40. The stub 52 defines a cable opening 54 (see FIG. 4) for receiving the fiber optic feeder cable 22. The cable opening 54 defines an axis 56 (shown in FIG. 4) that extends longitudinally through a length of the hardened fan-out device 24. In certain examples, a shape-memory sleeve 58 (e.g., a heat-shrink sleeve containing adhesive, see FIG. 5) can be mounted over the stub 52 and the end portion of a jacket of the feeder cable 22 to provide sealing between the fiber optic feeder cable 22 and the hardened fan-out device 24.

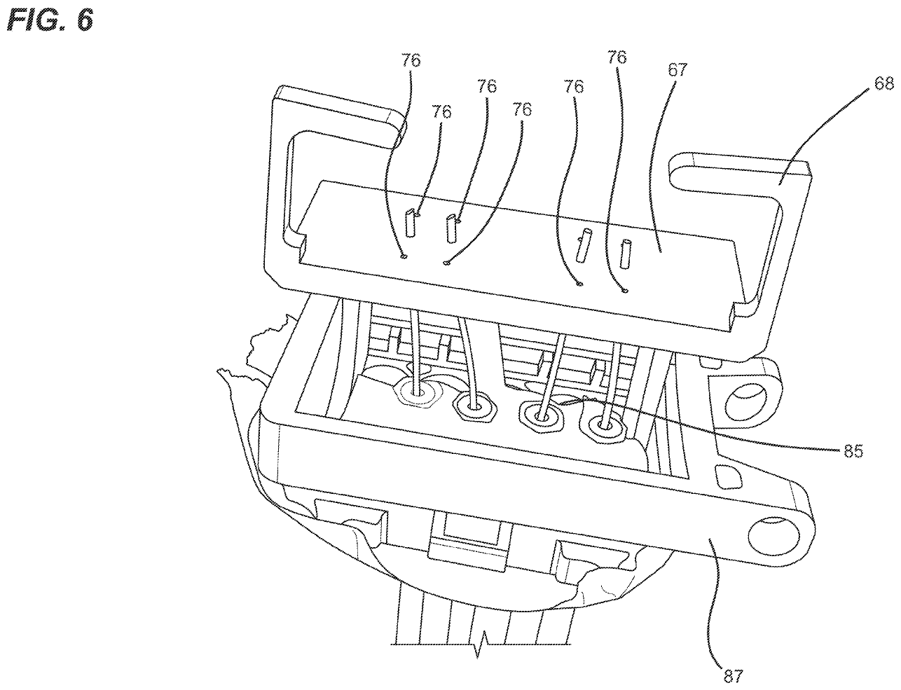

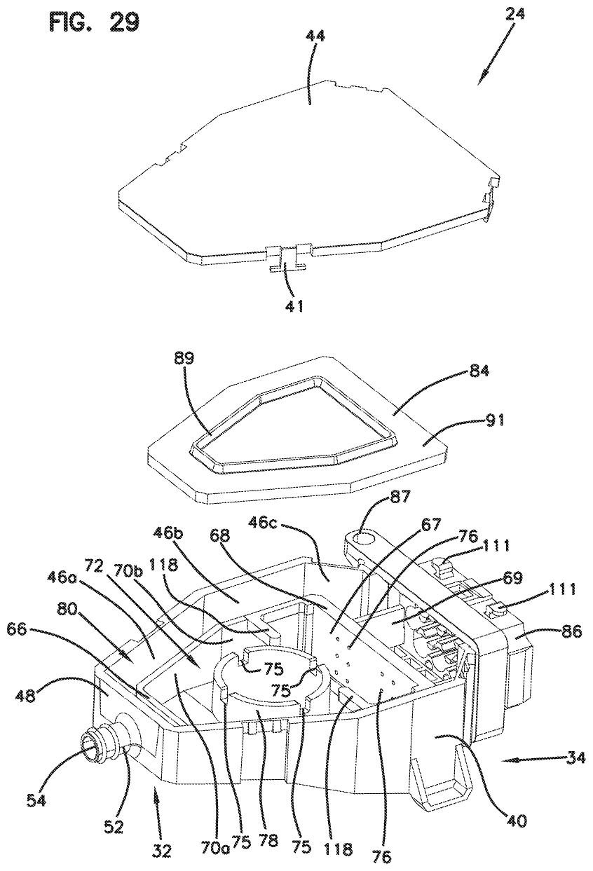

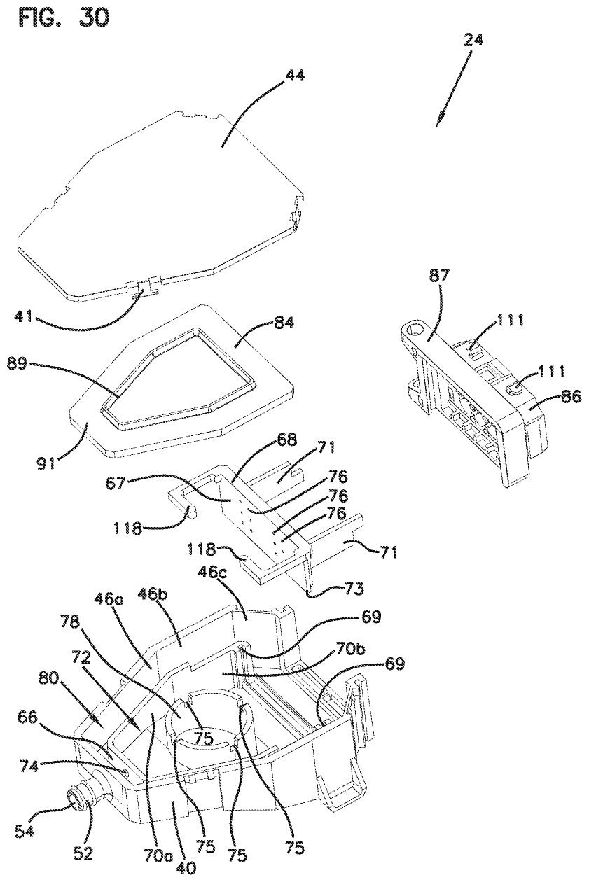

Referring still to FIG. 2, the hardened fan-out device 24 includes an inner housing 60 (e.g., inner pocket). The inner housing 60 can be configured inside of the outer housing 38. The inner housing 60 includes a distal end 62 and a proximal end 64 that respectively align with the first and second ends 32, 34 of the outer housing 38. In certain examples, the base 42 of the outer housing 38 can be disposed in the inner housing 60 to form a base of the inner housing 60. The inner housing 60 can include a first end-wall structure 66 positioned at the proximal end 64 and a second end-wall structure 68 (see FIG. 7) positioned at the distal end 62. The inner housing 60 can include two pairs of opposing side walls 70a-b positioned between the first and second end-wall structures 66, 68 that together define an inner cavity 72 of the inner housing 60. The first end-wall structure 66 of the inner housing 60 defines a cable entrance opening 74 (see FIGS. 5 and 30) and the second end-wall structure 68 of the inner housing 60 defines a plurality of fiber openings 76 (see FIG. 6). The plurality of fiber openings 76 defined in the second end-wall structure 68 can be arranged in rows, although alternatives are possible. In certain examples, the two pairs of opposing side walls 70a-b may include two pairs of identical opposing side walls, although alternatives are possible.

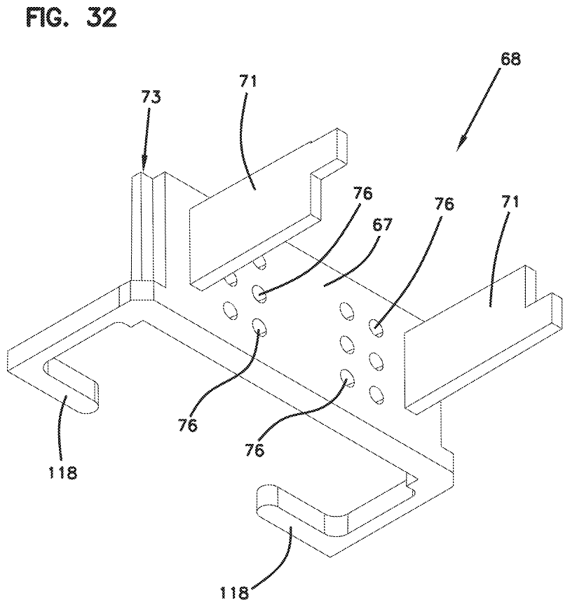

In certain examples, the second end-wall structure 68 can be secured to the inner housing 60 by a mechanical or adhesive attachment technique. In the depicted example, the second end-wall structure 68 connects to the inner housing 60 by a mechanical interlock. For example, the second end-wall structure 68 can include rails 73 (see FIGS. 30 and 32) that fit within corresponding channels 69 (see FIG. 4) defined by side walls 70 of the inner housing 60. In other examples, the rails and the channels can be reversed such that the inner housing includes rails that fit within corresponding channels defined by the second end-wall structure 68. The rail and channel configuration allows the second end-wall structure 68 to be secured to the inner housing 60 by a slide-lock configuration including a slidable connection interface. In other examples, a snap-fit configuration can be used. The second end-wall structure 68 may include a main body 67 (see FIGS. 30 and 32) with a pair of arms 71 (see FIGS. 30 and 32) that extend outwardly therefrom. The arms 71 are perpendicularly positioned relative to the main body 67, although alternatives are possible. The arms 71 may be adapted to engage with the mounting feature 87 when the sealing gel block 86 is positioned at the second end 34 of the outer housing 38.

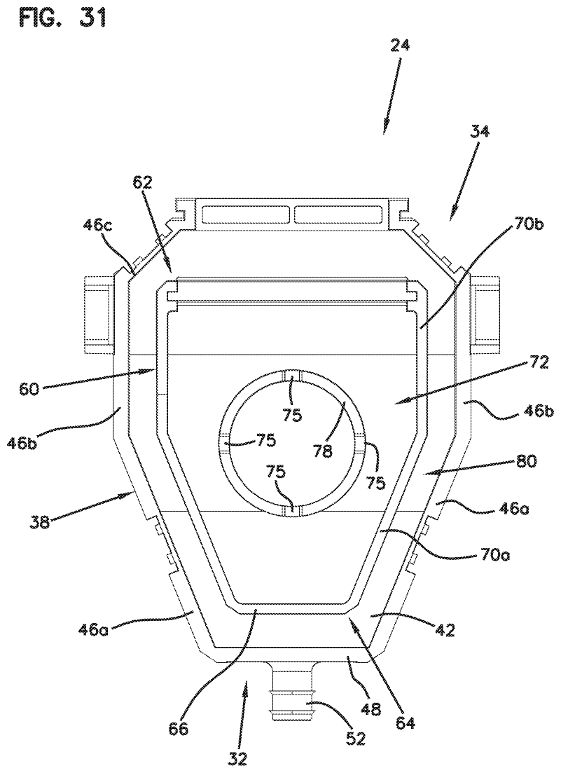

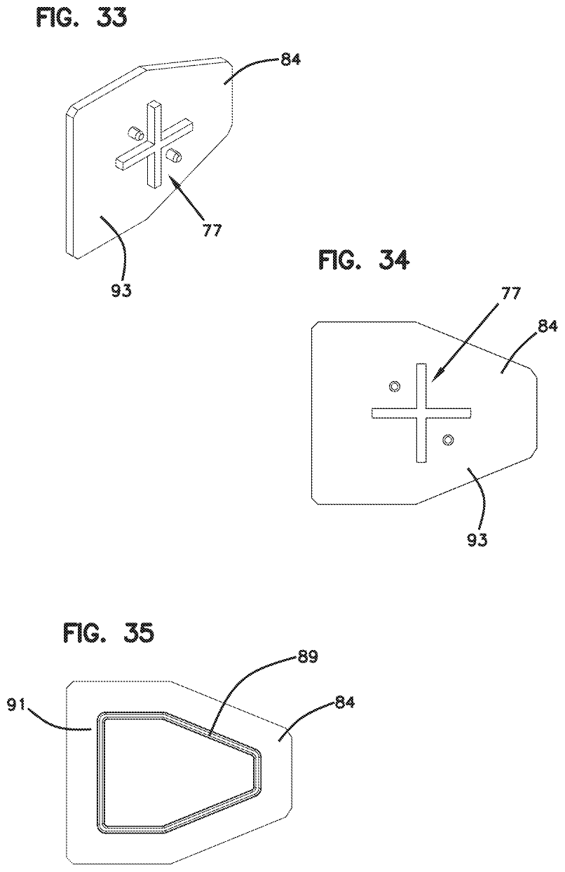

In certain examples, the inner cavity 72 of the inner housing 60 can include a round feature 78 (e.g., guide, cable spool, surface, post, wall) for storing and managing the slack (e.g., extra length) of the optical fibers 36 of the fiber optic feeder cable 22. The round feature 78 may define a plurality of slots 75 (e.g., apertures, openings) (see FIGS. 7, 29, and 31) respectively positioned circumferentially thereabout, although alternatives are possible. The plurality of slots 75 being arranged and configured to receive a mechanical interface 77 defined on a second surface 93 (e.g., bottom surface, bottom side) (see FIGS. 33-34) of the inner cover 84. In the example depicted, the mechanical interface 77 may include bars (e.g., ridges, beams,) and separate pins or projections, although alternatives are possible. The bars may have a X-shaped configuration that are arranged and configured to align with the plurality of slots 75 defined in the round feature 78 such that when the inner cover 84 is attached to the inner housing 60, the anchoring bars can be inserted into or received by the plurality of slots 75.

The slack of the optical fibers 36 may be used to adjust the length of particular extensions during connectorization. The optical fibers 36 can be adapted to expand or contract due to shrinkage of the cable in order to avoid damage to the optical fibers 36. It is preferred for no splices to be provided within the hardened fan-out device 24.

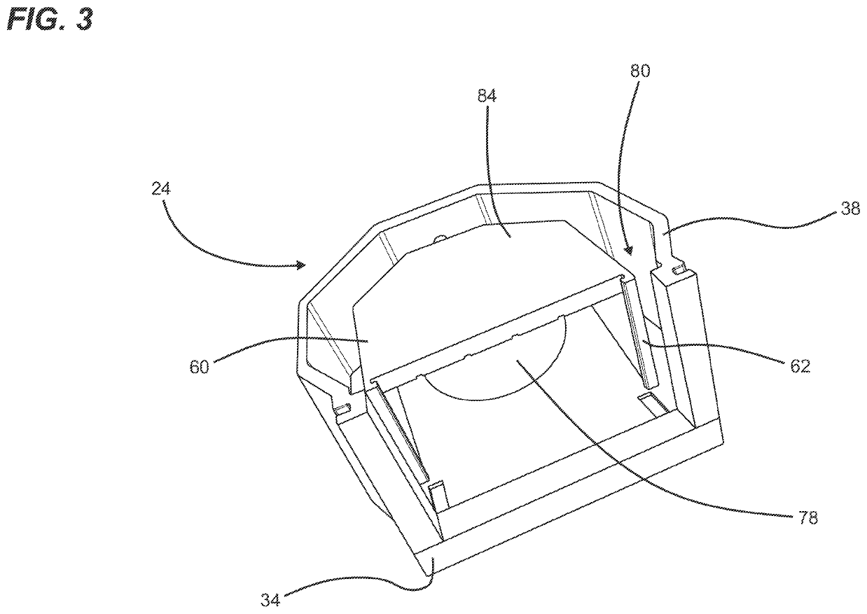

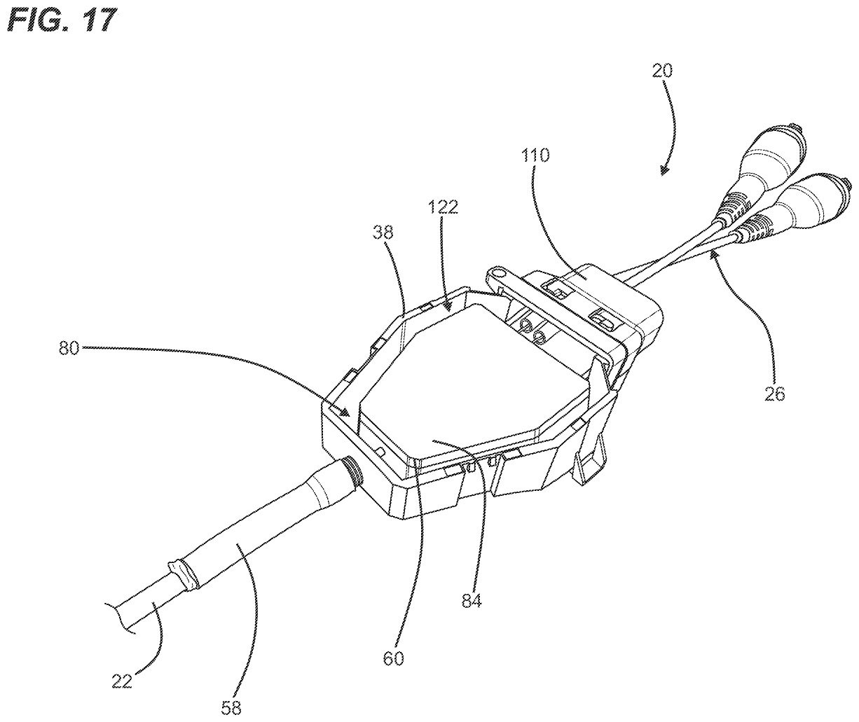

Turning to FIGS. 3-5, the hardened fan-out device 24 defines a volume of space 80 circumferentially between the outer housing 38 and the inner housing 60. The volume of space 80 can be adapted to form a flow passage for an encapsulating/filling material 82 (e.g., potting material, such as epoxy) (see FIG. 18) to help increase crush resistance. An inner cover 84 (e.g., second cover) is shown positioned over and fitted onto the inner housing 60 to prevent any encapsulating/filling material 82 from entering the inner housing 60 when the encapsulating/filling material 82 is filled within the volume of space 80 and over the inner cover 84. The outer cover 44 can be adapted to be positioned over and fitted onto the outer housing 38 such that the volume of space 80 and the inner cover 84 of the inner housing 60 are enclosed as shown in FIG. 1.

In certain examples, the outer and inner covers 44, 84 can be initially secured respectively to the outer and inner housings 38, 60 by a mechanical attachment interface. As depicted, the latching arrangement of the outer cover 44 optionally includes T-shaped latches 41 (see FIG. 29), although alternatives are possible. In one example, the mechanical attachment interface can include a snap-fit connection.

Turning to FIGS. 6-7, the hardened fiber optic fan-out assembly 20 is depicted with a sealing gel block 86 (e.g., end-wall) positioned at the second end 34 of the outer housing 38. The sealing gel block 86 defining a plurality of pigtail openings 85 (see FIG. 6). The sealing gel block 86 can define the second end 34 of the outer housing 38. In certain examples, the sealing gel block 86 can be secured to the outer housing 38 by a mechanical or adhesive attachment technique. In certain examples, the sealing gel block 86 connects to the outer housing 38 by a mechanical interlock. In other examples, a snap-fit configuration can be used. The sealing gel block 86 includes crimp bands 88 crimped on ends of the optical fibers 36 to prevent the cables from being disengaged from the sealing gel block 86.

In certain examples, the sealing gel block 86 can also include a mounting feature 87 for securing the hardened fan-out device 24 to a structure such as a wall, a pole, a hand-hole, a bracket, a cable, a wire or other structure by a fastener or other connection structure. In certain examples, the mounting feature 87 can include a tab defining an opening. In certain examples, the mounting feature 87 can work in combination with brackets and other fastening elements (e.g., fasteners such as bolts or screws, bracket arrangements, clips, ties such as cable ties, straps, bands or other structures) to allow the hardened fan-out device 24 to be secured in place at a given mounting location relative to a given structure. In certain examples, the mounting feature 87 may be integral with (e.g., formed in one seamless piece with) or coupled to, the mounting feature 87, although alternatives are possible.

Turning to FIGS. 7A-7C, the plurality of fiber optic pigtails 26 can each have a cable-like construction including an outer jacket 90 (e.g., a furcation tube) that contains a plurality of reinforcing members 92. The outer jacket 90 preferably has a round cross-sectional shape, but could also be flat. In preferred examples, the outer jackets 90 of the plurality of fiber optic pigtails 26 each have outer diameters less than the outer diameter of the fiber optic feeder cable 22 (see FIG. 7B). The reinforcing members 92 can provide tensile and/or compressive reinforcement to the plurality of fiber optic pigtails 26. In certain examples, the reinforcing members 92 are strand-like, string-like or yarn-like strength members such as Aramid yarns or fiberglass strength members. It is desirable for the reinforcing members 92 to provide tensile reinforcement, without preventing the plurality of fiber optic pigtails 26 from being readily bent and moved relative to one another. In certain examples, the reinforcing members 92 provide primarily tensile reinforcement and provide minimal to no compressive reinforcement so as to not interfere with the flexibility of the plurality of fiber optic pigtails 26. In certain examples, the plurality of fiber optic pigtails 26 are individually movable relative to one another.

The fiber optic feeder cable 22 can include an outer jacket 94 and an inner buffer tube 96 containing a plurality of optical fibers 98. In one example, the fiber optic feeder cable 22 has a round transverse cross-sectional shape (such as in the example shown in FIG. 7B), although flat feeder cables are also possible. In one example, the fiber optic feeder cable 22 can define an outer diameter less than 8 millimeters, or less than 7 millimeters, or less than 6 millimeters, or in the range of 4-7 millimeters.

It will be appreciated that the number of optical fibers within the buffer tube 96 can match the number of fiber optic pigtails attached to the hardened fan-out device 24, or can be different if more than one optical fiber is routed through one or more of the pigtails. Typically, four to twelve optical fibers are routed through the fiber optic feeder cable 22; but more or fewer optical fibers can also be provided. As depicted, twelve optical fibers 98 are provided within the buffer tube 96.

In certain examples, the buffer tube 96 can be a dry water-blocked central loose tube containing twelve individual, non-ribbonized optical fibers. Water blocking yarns can be provided within the loose buffer tube 96. In certain examples, the fiber optic feeder cable 22 can include reinforcement. For example, as shown at FIG. 7B, the reinforcement can include a layer 100 of reinforcing yarns such as Aramid yarn, and a layer 102 that may include water blocking fiberglass strength members. In certain examples, the strength members can include E-glass.

Referring now to FIG. 7C, in certain examples, each of the optical fibers 98 can include a central core 104 surrounding by a cladding layer 106 and a coating layer 108. In one example, the coating layer 108 can include a polymeric material such as acrylate that protects the interior cladding layer 106 and the central core 104. In one example, the coating layer 108 has an outer diameter less than or equal to 275 microns, or less than or equal to 260 microns, or less than or equal to about 250 microns.

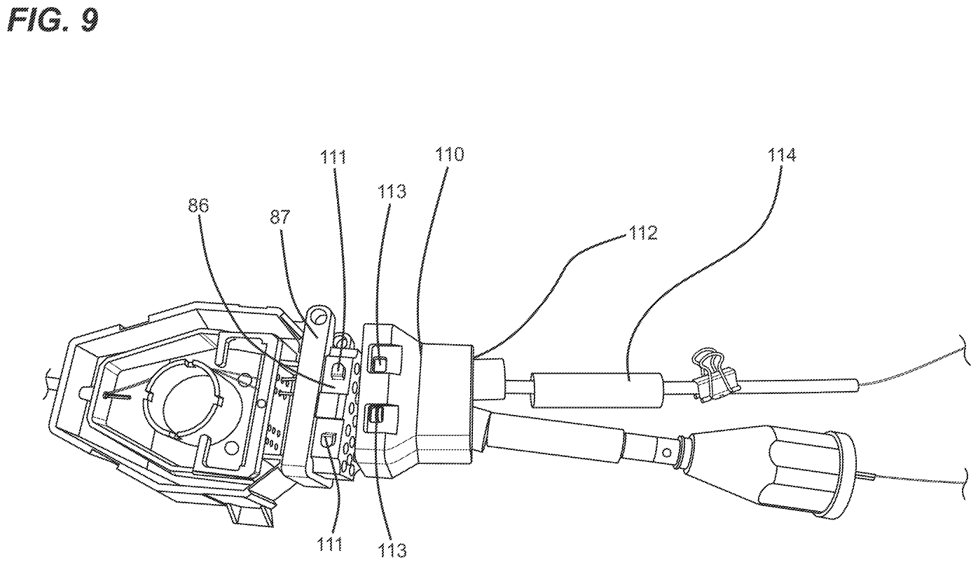

Referring now to FIGS. 8 and 9, the hardened fan-out device 24 further includes a boot-like structure 110 mounted to the sealing gel block 86. In certain examples, mounting features 111 can be received within apertures 113 of the boot-like structure 110, although alternatives are possible. The boot-like structure 110 can provide a bend radius limiting and/or strain relief function for the plurality of pigtails 26. The boot-like structure 110 optionally includes a single central, elongated, enlarged opening 112 in communication with the plurality of pigtail openings 85 of the sealing gel block 86. Thus, the plurality of fiber optic pigtails 26 are routed through the opening 112 to reach the plurality of pigtail openings 85. The interior of the opening 112 can include chamfers or curved surfaces for limiting the amount the plurality of fiber optic pigtails 26 can be bent at the second end 34 of the hardened fan-out device 24.

Optical fibers 36 can be routed from the fiber optic feeder cable 22 through the volume of space 80 and inner cavity 72 of the inner housing 60 of the hardened fan-out device 24 to the outer jackets 90 of the plurality of fiber optic pigtails 26. The optical fibers 36 are free to move within the inner housing 60. In other examples, splices may be provided within the hardened fan-out device 24, in which case fibers corresponding to the plurality of fiber optic pigtails 26 would be spliced to corresponding fibers of the fiber optic feeder cable 22 within the hardened fan-out device 24. In still other examples, a passive optical splitter or wavelength division multi-plexer can be provided within the hardened fan-out device 24. In this example, one fiber from the fiber optic feeder cable 22 can be coupled to an input of the splitter/wavelength division multi-plexer, and outputs of the splitter/wavelength division multi-plexer can be routed to the plurality of fiber optic pigtails 26.

In certain examples, the boot-like structure 110 can have a construction that is softer and/or more resilient than the sealing gel block 86 and the main body 40. In certain examples, the main body 40 and the sealing gel block 86 are made of a polymeric material such as molded plastic. In certain examples, a shape-memory sleeve (e.g., a heat shrink sleeve) 114 can be used to provide a seal for the hardened fan-out device 24 and a hardened connector.

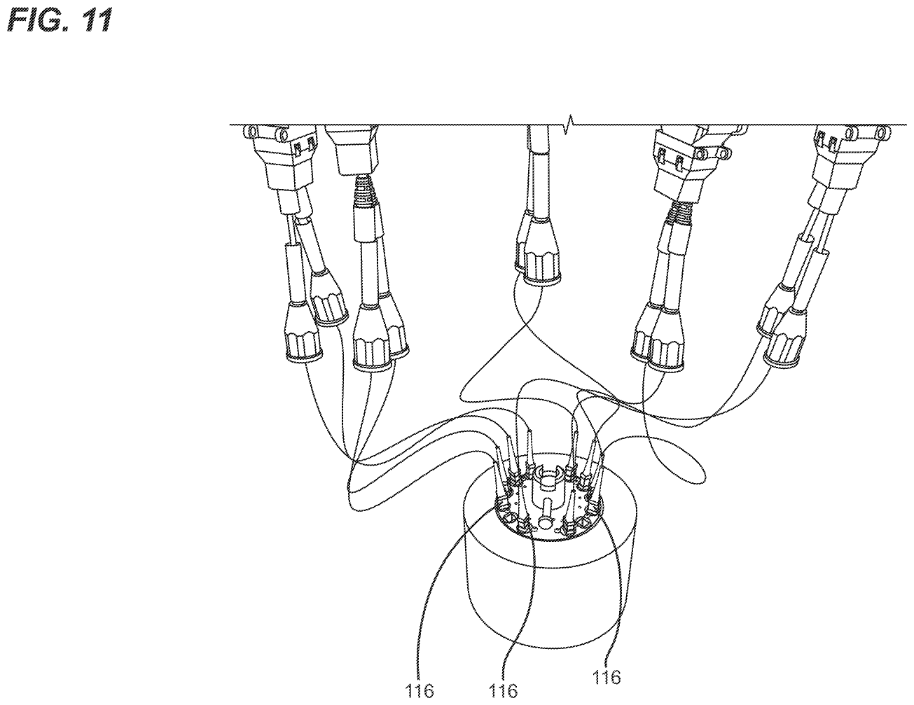

Turning to FIG. 11, the plurality of fiber optic pigtails 26 are shown extended from the hardened fiber optic fan-out assembly 20 to allow the plurality of fiber optic pigtails 26 to be connectorized. Example fiber optic connectors 116 are shown mounted at the ends 28 of the plurality of fiber optic pigtails 26. Alternatively, at least some of the pigtails can include more than two optical fibers and can have free ends terminated by hardened multi-fiber fiber optic connectors that can accommodate more than two optical fibers (e.g., the connectors can include ferrules that each receive more than two optical fibers) or a SC hardened connector. The fiber optic connectors can include ferruled connectors and ferrule-less connectors.

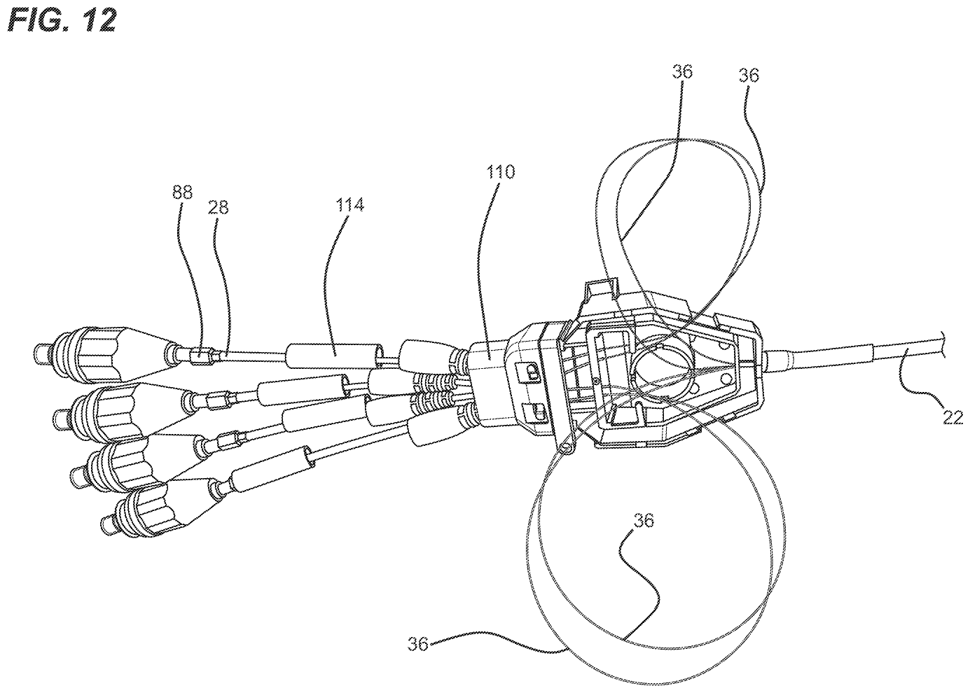

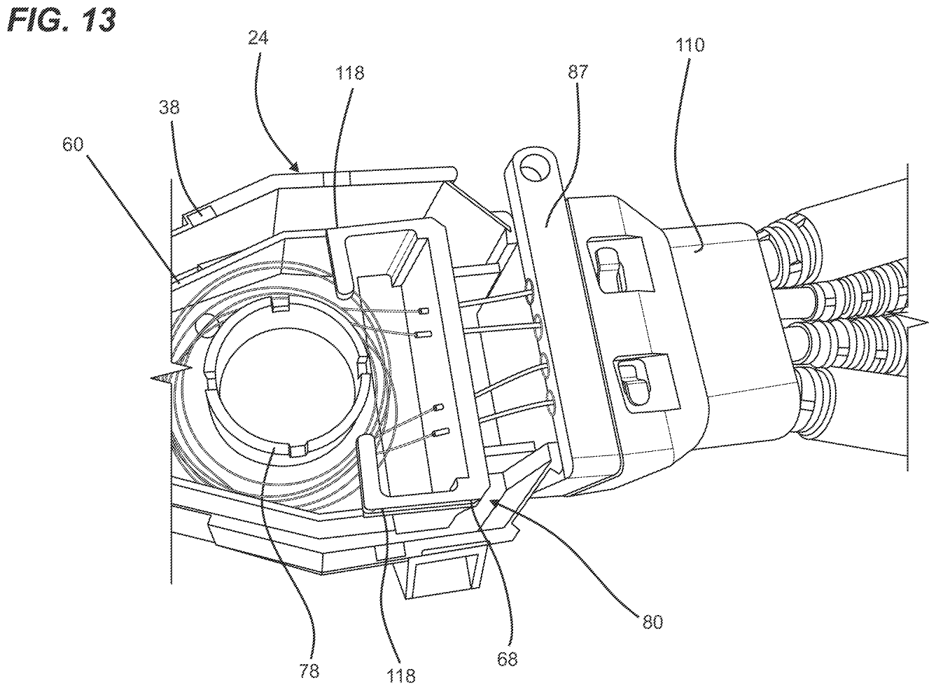

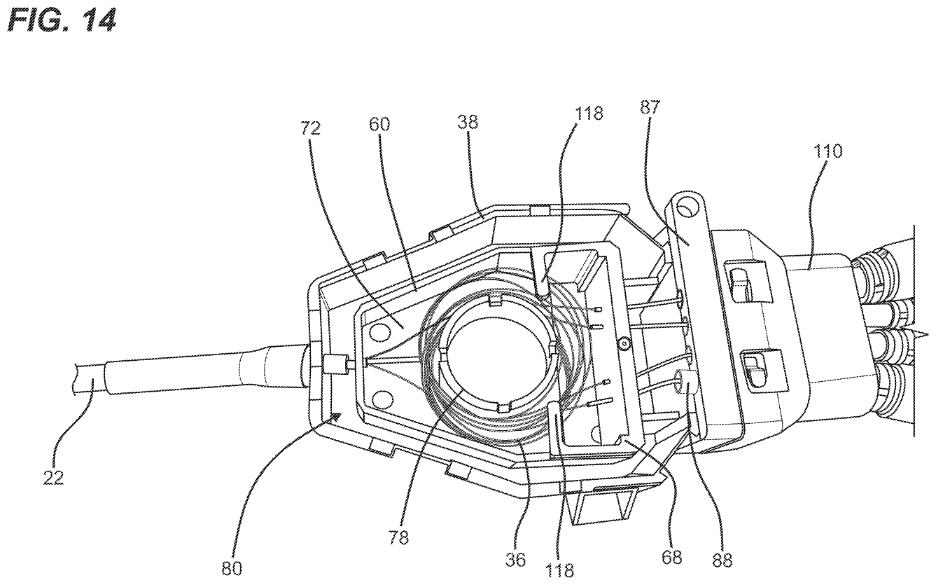

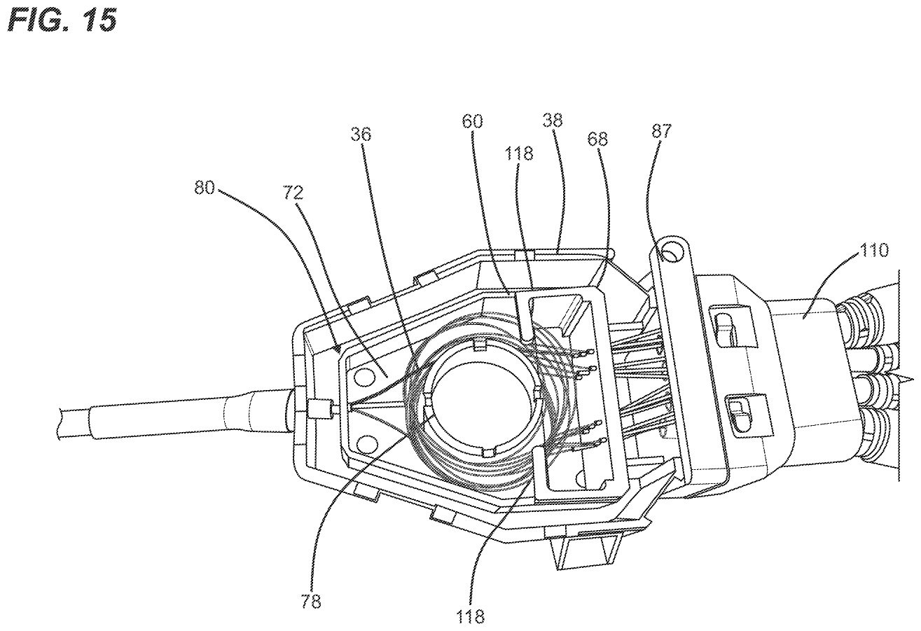

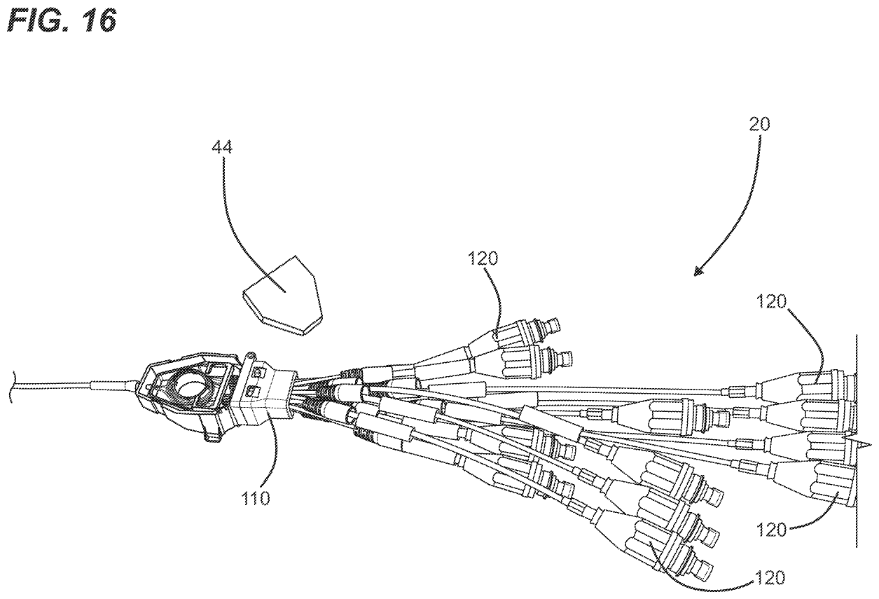

Turning to FIGS. 12-16, the hardened fan-out device 24 is depicted with the optical fibers 36 of the plurality of fiber optic pigtails 26 pulled back inside of the hardened fan-out device 24. Once the plurality of fiber optic pigtails 26 have been connectorized, the slack of the optical fibers 36 can be wound up (e.g., coiled, stored, managed) on the round feature 78 within the inner housing 60 as depicted. A plurality of optical fibers 36 as shown in FIG. 15 can be coiled about the round feature 78. The second end-wall structure 68 can include fiber retention arms 118 adapted to help and retain the plurality of optical fibers 36 about the round feature 78, although alternatives are possible. In certain examples, the fiber retention arms 118 may be integral with (e.g., formed in one seamless piece with) or coupled to, the main body 67 of the second end-wall structure 68, although alternatives are possible. The hardened fiber optic fan-out assembly 20 is depicted in FIG. 16 with the plurality of fiber optic pigtails 26 with hardened de-mateable fiber optic connectors 120.

Turning to FIG. 17, the hardened fan-out device 24 is depicted with the inner cover 84 attached to the inner housing 60. In certain examples, the inner cover 84 may have a lip 89 that extends outwardly from a first surface 91 (e.g., top surface, top side) (see FIG. 29) thereof, although alternatives are possible. The inner housing 60 and inner cover 84 together define a chamber 122 within the outer housing 38 of the hardened fan-out device 24. The inner housing 60 can be sealed off from the encapsulating/filling material 82. The chamber 122 and the outer housing 38 can define the volume of space 80.

Turning to FIG. 18, the encapsulating/filling material 82 is depicted within the volume of space 80 of the hardened fan-out device 24 to fill the space 80 and encapsulate an end of the fiber optic feeder cable 22 routed there-through and to encapsulate ends of the plurality of fiber optic pigtails 26 within the outer housing 38. The encapsulating/filling material 82 does not enter the inner housing 60 of the hardened fan-out device 24 such that the optical fibers 36 can be free to move within the inner housing 60. That is, the encapsulating/filling material 82 can fill the outer housing 38 while the inner housing 60 or the chamber 122 remains dry (e.g., free of the encapsulating/filling material 82). Thus, if the outer jacket 90 shrinks, the optical fibers 36 are free to expand and/or contract within the inner housing 60. The optical fibers 36 can easily have room to move within the inner housing 60.

In certain examples, the encapsulating/filling material 82 can have adhesive properties and can bond to ends of the optical fibers 36 within the outer housing 38 while remaining outside of the inner housing 60. In certain examples, the encapsulating/filling material 82 can prevent water from entering the hardened fan-out device 24. In one example, the encapsulating/filling material 82 can include a curable material. In one example, the encapsulating/filling material 82 can include an epoxy material.

In certain examples, an end portion of the fiber optic feeder cable 22 as well as end portions of the plurality of fiber optic pigtails 26 can extend into the volume of space 80 of the hardened fan-out device 24 and can be embedded in and bonded to the encapsulating/filling material 82. In certain examples, the portions of the cables extending into the volume of space 80 can include cable jackets and cable strength members (e.g., reinforcing yarns such as Aramid yarns, fiberglass strength members, or other reinforcing elements). In certain examples, the sealing gel block 86 can function as a barrier for preventing the encapsulating/filling material 82 from flowing out of the volume of space 80 of the hardened fan-out device 24 during the filling process. Preferably, the encapsulating/filling material 82 is curable and solidifies when cured. In certain examples, the encapsulating/filling material 82 can be cured by temperature, ultraviolet light or other means. Preferably, the encapsulating/filling material 82 has adhesive bonding properties.

By removing the outer cover 44, the hardened fan-out device 24 is open to provide access to outer housing 38 for routing fibers 36 through the interior from the fiber optic feeder cable 22 to the plurality of fiber optic pigtails 26. After the optical fibers 36 have been routed through the hardened fan-out device 24, the inner cover 84 is placed over the inner housing 60 prior to introducing the encapsulating/filling material 82 into the volume of space 80. Once the volume of space 80 has been filled with the encapsulating/filling material 82, the outer cover 44 can be mounted to (e.g., positioned on, fitted on) the outer housing 38 to enclose the inner housing 60 of the hardened fan-out device and the volume of space 80.

In certain examples, when the encapsulating/filling material 82 cures, the outer cover 44 can be bonded permanently in place with respect to the base 42. In other examples, the hardened fan-out device 24 can define an injection port for injecting the encapsulating/filling material 82 into the volume of space 80 with the outer cover 44 pre-mounted in place on the outer housing 38 of the hardened fan-out device 24.

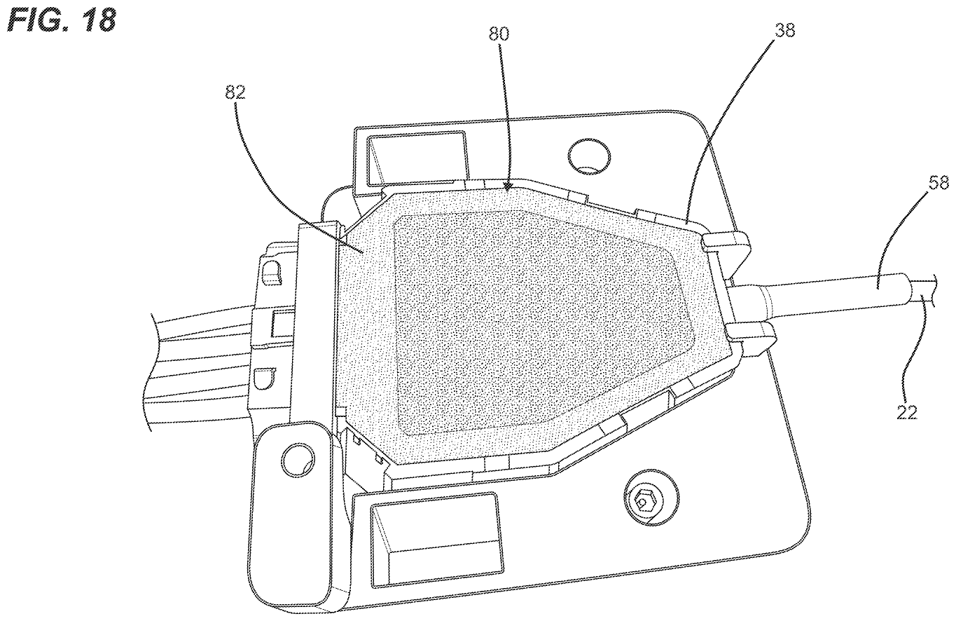

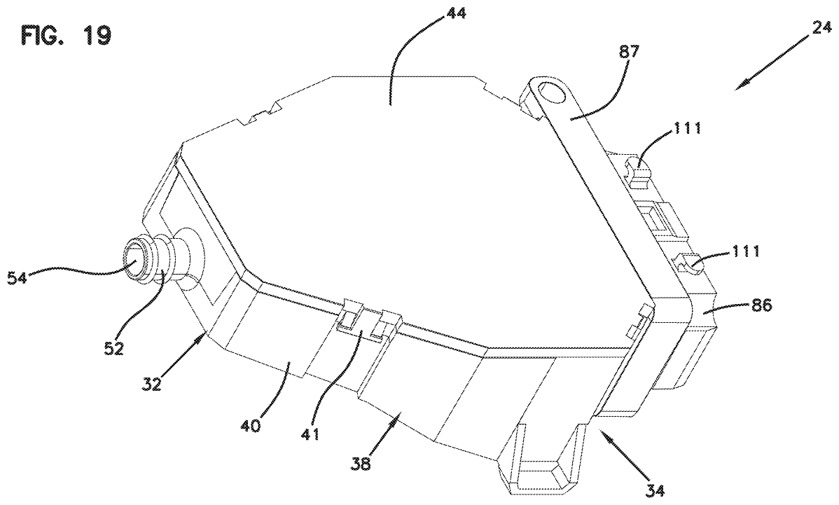

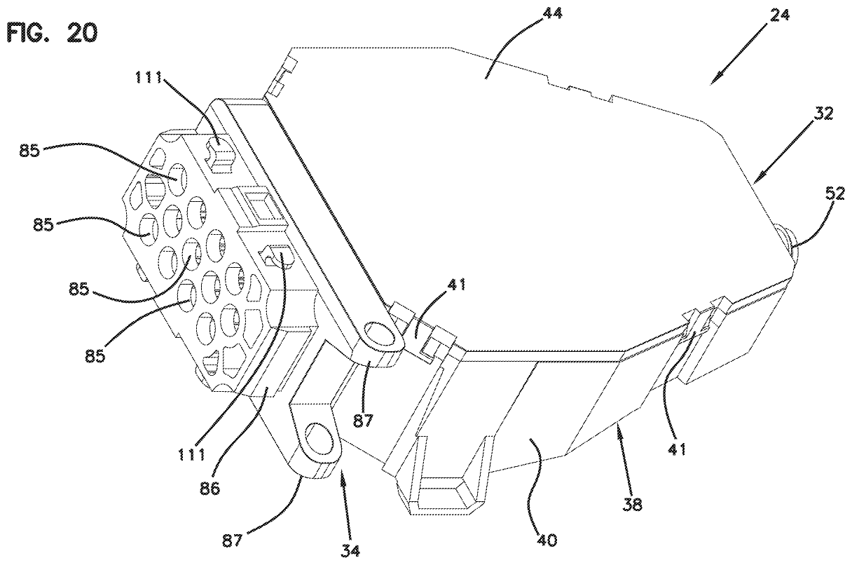

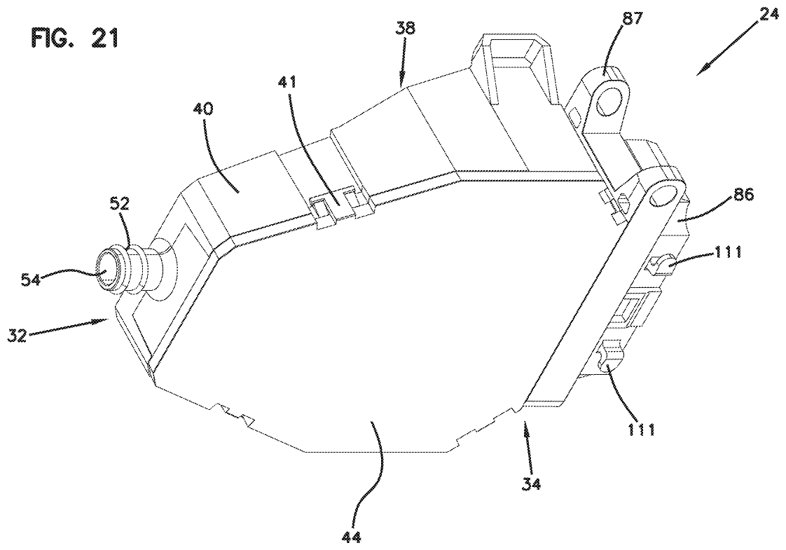

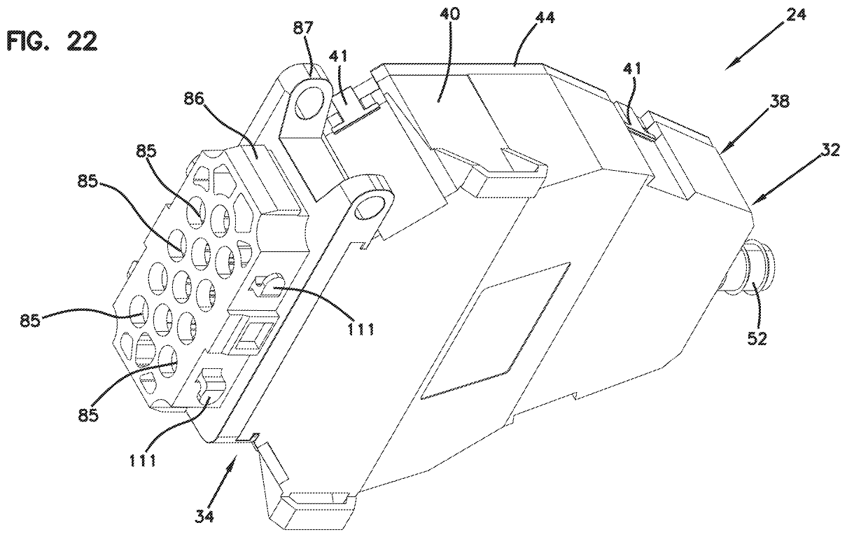

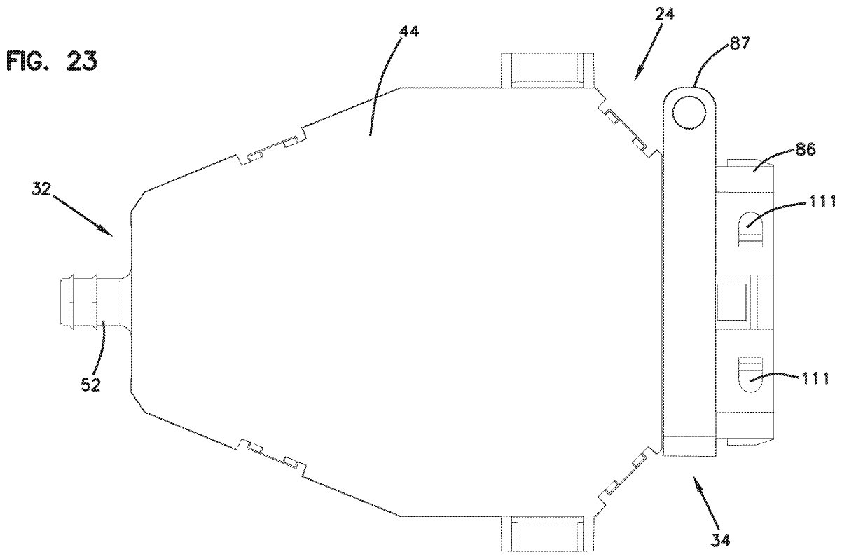

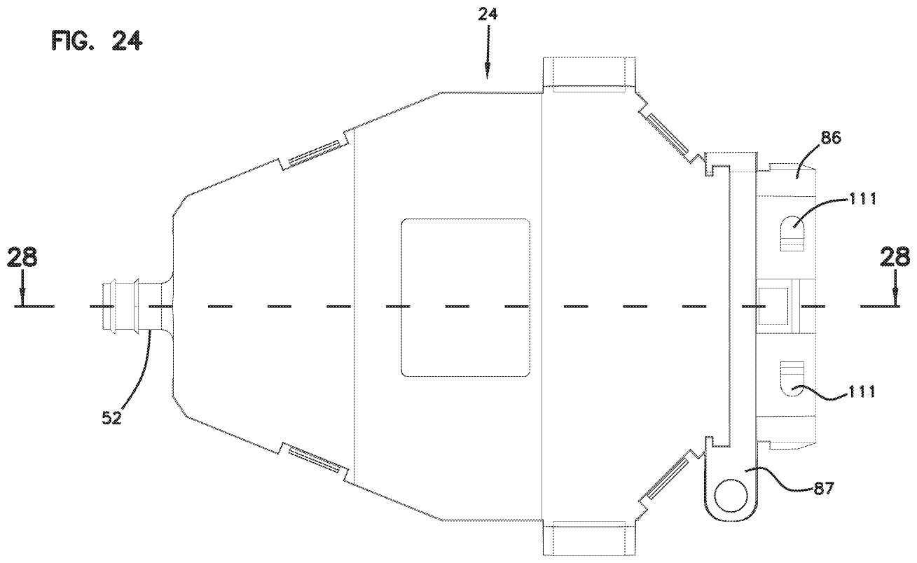

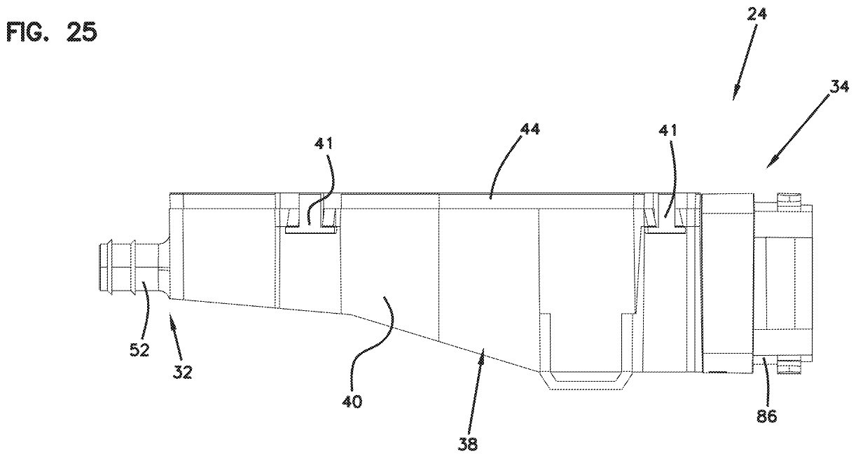

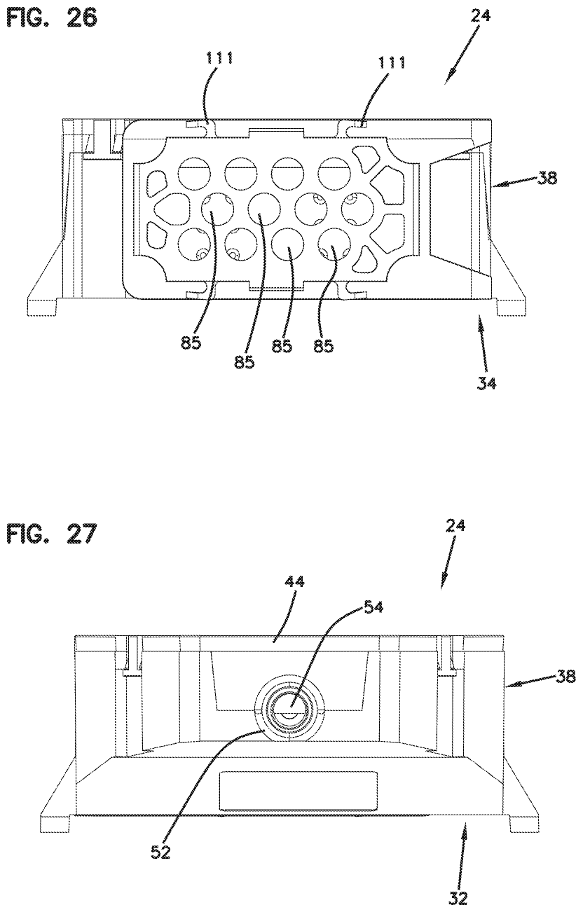

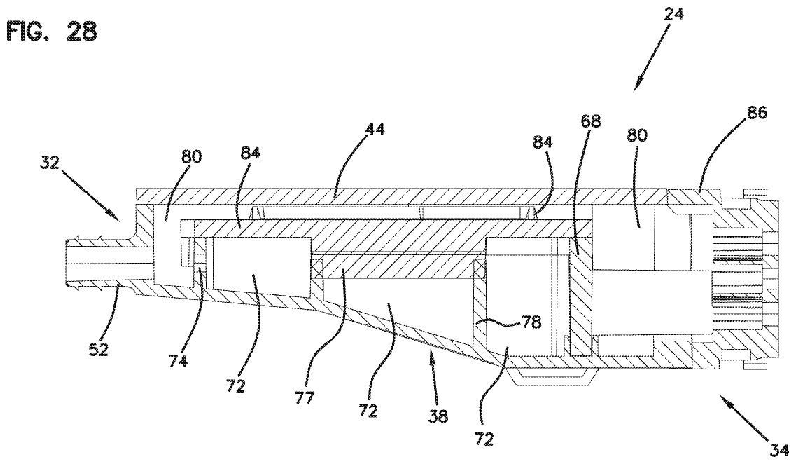

FIGS. 19-35 are multiple views of the hardened fan-out device 24 described above with reference to FIGS. 1-18.

The present disclosure further relates to a method of fabricating the hardened fiber optic fan-out assembly 20 for the fiber optic feeder cable 22 which includes the plurality of fiber optic pigtails 26. The method can include the following steps: 1) providing the hardened fan-out device 24, the hardened fan-out device 24 can include the outer housing 30 and the inner housing 60. The volume of space 80 can be defined between the outer and inner housings 38, 60; 2) routing the optical fibers 36 from the fiber optic feeder cable 22 through the hardened fan-out device 24 to the plurality of fiber optic pigtails 26; 3) terminating the free ends 28 of the plurality of fiber optic pigtails 26 to the plurality of fiber optic connectors 120; 4) routing excess slack of the optical fibers 36 about the round feature 78 positioned within the inner housing 60 of the hardened fan-out device 24; 5) covering the inner housing 60 of the hardened fan-out device 24 with the inner cover 84; 6) applying filling material 82 over the inner housing and into the volume of space 80 defined between the outer and inner housings 38, 60, wherein the filling material 82 does not enter the inner housing 60; and 7) covering the outer housing 38 of the hardened fan-out device 24 with an outer cover 44 to enclose the inner cover 84 and the inner housing 60 of the hardened fan-out device 24. It will be appreciated that method steps described herein may be performed in a different order. It will be appreciated that the method steps described herein may be performed in order where implicitly required. For example, the step of applying the filling material 82 can be performed after covering the inner housing in which the filling material 82 may be applied through a filling port opening in the hardened fan-out device 24, although alternatives are possible. In certain examples, the step of covering the outer housing 38 can be performed after applying the filling material 82, although alternatives are possible.

The step of terminating the free ends 28 includes pulling the plurality of fiber optic pigtails 26 away from the hardened fan-out device 24 to provide easy access to pieces within a connector. The excess length of optical fibers can be pulled back into the hardened fan-out device 24 after the termination process. The step of routing the optical fibers 36 through the hardened fan-out device 24 is without any splices within the hardened fan-out device 24. The step of providing the hardened fan-out device 24 includes providing a hardened fan-out device 24 having an in-line configuration.

Various modifications and alterations of this disclosure will become apparent to those skilled in the art without departing from the scope and spirit of this disclosure, and it should be understood that the scope of this disclosure is not to be unduly limited to the illustrated examples set forth herein.

What is claimed is:

1. A hardened fan-out device comprising:
an outer housing including a main body formed by a base and an outer cover, the outer housing having a first end and an opposite second end;
an inner housing configured to be located inside of the outer housing, the inner housing having a distal end and a proximal end that respectively align with the first and second ends of the outer housing;
a space defined circumferentially between the outer housing and the inner housing, the space being adapted to form a flow passage for a filling material; and
an inner cover adapted to be positioned on and fitted on the inner housing such that the filling material is prevented from flowing into the inner housing;
the outer cover being adapted to be positioned on and fitted on the outer housing such that the space and the inner cover of the inner housing are enclosed.

2. The hardened fan-out device of claim 1, wherein the base of the outer housing is disposed in the inner housing.

3. The hardened fan-out device of claim 2, wherein the main body of the outer housing includes three pairs of opposing side walls and an end wall, the three pairs of opposing side walls and the end wall extending upwardly from the base.

4. The hardened fan-out device of claim 3, wherein at least two of the three pairs of opposing side walls are tapering walls.

5. The hardened fan-out device of claim 3, wherein the end wall is positioned at the first end of the outer housing and defines a first opening.

6. The hardened fan-out device of claim 1, wherein the inner housing includes a first end-wall structure positioned at the proximal end, and a second end-wall structure positioned at the distal end, the inner housing including two pairs of opposing side walls positioned between the first and second end-wall structures that together define an inner cavity of the inner housing.

7. The hardened fan-out device of claim 6, wherein the first end-wall structure of the inner housing defines a cable entrance opening and the second end-wall structure of the inner housing defines a plurality of pigtail openings.

8. The hardened fan-out device of claim 6, wherein the cavity of the inner housing includes a spool inside thereof.

9. The hardened fan-out device of claim 1, further comprising a sealing gel block positioned at the second end of the outer housing.

10. A hardened fiber optic fan-out arrangement comprising:
a hardened fan-out device having an in-line configuration, the hardened fan-out device including:
an outer housing having a first end and an opposite second end;
an inner housing configured to be located inside of the outer housing, the inner housing having a distal end and a proximal end that respectively align with the first and second ends of the outer housing;
a space defined circumferentially between the outer housing and the inner housing, the space being adapted to form a flow passage for a filling material; and
an inner cover adapted to be positioned on and fitted on the inner housing, the inner cover and inner housing together forming a chamber within the outer housing such that the filling material is prevented from flowing into the chamber; and
an outer cover being adapted to be positioned on and fitted on the outer housing such that the space and the chamber are enclosed;
a plurality of fiber optic pigtails that project outwardly from the second end of the hardened fan-out device; and
a fiber optic feeder cable that projects outwardly from the first end of the hardened fan-out device, the fiber optic feeder cable being optically coupled to the plurality of fiber optic pigtails;
wherein optical fibers are routed from the fiber optic feeder cable through the hardened fan-out device to the plurality of fiber optic pigtails;
wherein the filling material encapsulates an end of the fiber optic feeder cable within the outer housing and encapsulates ends of the plurality of fiber optic pigtails within the outer housing; and
wherein the filling material does not encapsulate the optical fibers within the inner housing such that the optical fibers are configured to move freely.

11. The hardened fiber optic fan-out arrangement of claim 10, wherein the optical fibers are routed through the hardened fan-out device without any splices within the hardened fan-out device.

12. The hardened fiber optic fan-out arrangement of claim 10, wherein the hardened fan-out device includes an end-wall defining separate openings for each of the plurality of fiber optic pigtails.

13. The hardened fiber optic fan-out arrangement of claim 12, wherein the end-wall is secured to the outer housing of the hardened fan-out device by a slide-fit interface.

14. The hardened fiber optic fan-out arrangement of claim 12, further comprising a boot-like structure mounted on the end-wall which defines an enlarged single opening for receiving the plurality of fiber optic pigtails routed to the openings defined in the end-wall.

15. The hardened fiber optic fan-out arrangement of claim 10, wherein the plurality of fiber optic pigtails have free ends that include hardened de-mateable fiber optic connection interfaces.

16. The hardened fiber optic fan-out arrangement of claim 15, wherein the hardened de-mateable fiber optic connection interfaces include twist-to-lock connection interfaces.

17. The hardened fiber optic fan-out arrangement of claim 16, wherein the twist-to-lock connection interfaces include threads or bayonet style connection interfaces.

18. A method of fabricating a fan-out assembly for a fiber optic feeder cable which includes a plurality of fiber optic pigtails, the method comprising:
providing a hardened fan-out device, the hardened fan-out device having an outer housing and an inner housing, a space being defined between the outer and inner housings;
routing optical fibers from the fiber optic feeder cable through the hardened fan-out device to the plurality of fiber optic pigtails;
terminating free ends of the plurality of fiber optic pigtails to a plurality of fiber optic connectors;
routing excess slack of the optical fibers about a spool positioned within the inner housing of the hardened fan-out device;
covering the inner housing of the hardened fan-out device with an inner cover;
applying a filling material over the inner housing and into the space defined between the outer and inner housings, wherein the filling material does not enter the inner housing; and
covering the outer housing of the hardened fan-out device with an outer cover to enclose the inner cover and inner housing of the hardened fan-out device.

19. The method of claim 18, wherein the step of routing the optical fibers through the hardened fan-out device is without any splices within the hardened fan-out device.

20. The method of claim 18, wherein the step of providing the hardened fan-out device includes providing a hardened fan-out device having an in-line configuration.
